(19) United States
(12) Patent Application Publication
(10) Pub. No.: US 2009/0026944 A1
(43) Pub. Date: Jan. 29, 2009

(54) FIELD EMISSION CATHODE STRUCTURE AND METHOD OF MAKING THE SAME

(76) Inventor: Lionel J. Riviere-Cazaux, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/782,070

(22) Filed: Jul. 24, 2007

(51) Int. Cl. H01J 3/00; H01J 1/62; H01J 9/02

(52) U.S. Cl. 313/506; 445/23

(57) ABSTRACT

A method for making a field emission cathode structure includes forming a ballast layer over a column metal layer, forming a dielectric layer over the ballast layer, forming a line metal layer over the dielectric layer, forming a trench in the line metal layer and the dielectric layer, the trench extending to the ballast layer, and forming a sidewall spacer and a sidewall blade adjacent a sidewall of the trench, where the sidewall spacer is between the dielectric layer and the sidewall blade, and where the conformal spacer is recessed as compared to the sidewall blade such that a gap is present between the sidewall blade and the line metal layer.

### BACKGROUND

1. Field

This disclosure relates generally to field emission cathode structures, and more specifically, to field emission cathode structures featuring blade emitters and methods of making the same.

2. Related Art

Field Emission Displays (FEDs) are a form of flat CRT (Cathode Ray Tube). Thousands of electron emitters replace the single scanning e-beam of a typical CRT and also allow for manufacturing of a very flat CRT. However, costs for manufacturing FED cathode displays have been prohibitive. The cost of manufacturing of the FED cathode is a major impediment for this technology. This cost is driven by the need to use (i) expensive and low throughput equipment, for example, high resolution scanners and evaporation tools, or (ii) exotic technologies, for example, carbon nanotubes.

In addition, one known lateral-emitter field-emission device makes use of horizontal blades. However, such horizontal blades of the lateral-emitter field-emission device are unsuitable for being subjected to a roughening treatment. In addition, a face to face surface ratio of the horizontal blades of the lateral-emitter field-emission device to a corresponding extraction grid is very high and is also very sensitive to dielectric breakdown. While such a process for making horizontal blades is low cost, the method does not sufficiently allow for manufacturing effective and reliable emitters.

Accordingly, there is a need for an improved method and apparatus for overcoming the problems in the art as discussed above.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIGS. 1-5 are cross-sectional views of a field emission cathode structure featuring blade emitters at various stages of manufacture thereof and which is formed according to one embodiment of the present disclosure;

FIG. 6 is a cross-sectional view of a field emission cathode structure featuring blade emitters formed with emission enhanced blade tips according to another embodiment of the present disclosure;

FIG. 7 is a partial cross-sectional and schematic view of a portion of the field emission cathode structure of FIG. 6 illustrating Fowler-Nordheim tunneling extraction of electrons from the emission enhanced blade tips;

FIGS. 8-9 are cross-sectional views of a portion of a field emission cathode structure featuring blade emitters at various stages of manufacture thereof and which is formed according to another embodiment of the present disclosure; and

FIGS. 10-12 are cross-sectional views of a portion of a field emission cathode structure featuring blade emitters at various stages of manufacture thereof and which is formed according to yet another embodiment of the present disclosure.

### DETAILED DESCRIPTION

The method and apparatus according to the embodiments of the present disclosure advantageously provide a novel integration scheme that greatly reduces a cost of manufacturing of FEDs. The method and apparatus also provide for the manufacturing of effective and reliable emitters.

According to the embodiments of the present disclosure, an FED includes a structure of vertical blade emitters. In the embodiments, a process integration to achieve the vertical blade emitter structures includes steps configured to increase the Fowler Nordheim effect of the vertical blade emitters. In one embodiment, a step configured to increase the Fowler Nordheim effect includes blade sharpening and micro structuration. In another embodiment, the step configured to increase the Fowler Nordheim effect includes layering of the vertical blade in order to increase its micro roughness.

The embodiments of the present disclosure overcome problems in the art, for example, with an electron emission enhancement obtained by treating the vertical blade structure with an anisotropic plasma. Such an anisotropic plasma would be detrimental for use in the case of the known lateral emitter structures, since it would undesirably attack the horizontal surfaces of the lateral emitter structure. In addition, the vertical blade structure according to the embodiments of the present disclosure also minimizes the face to face surface of emitter and extraction grid. Accordingly, this minimizes the risk of dielectric breakdown (e.g., a reliability concern) and the capacitance effect (e.g., a lower cost of drivers).

Accordingly, the embodiments of the present disclosure provide a method for the manufacturing of low cost/high reliability field emitters. While these emitters can be used for Field Emission displays, they can also be used as generic electron sources.

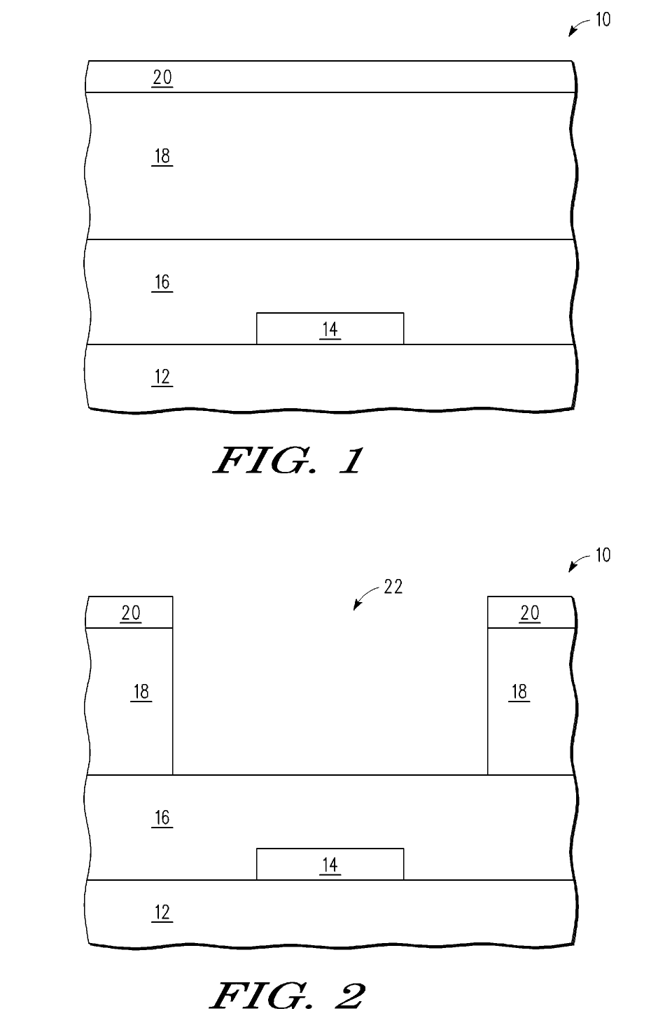

FIGS. 1-5 are cross-sectional views of field emission cathode structure 10 featuring blade emitters at various stages of manufacture thereof and which is formed according to one embodiment of the present disclosure. In FIG. 1, field emission cathode structure 10 includes a substrate 12, a column driver metal 14, a ballast layer 16, a dielectric layer 18, and a line driver metal layer 20. Substrate 12 comprises any suitable substrate, for example, including but not limited to a glass substrate, ceramic substrate, or the like. Substrate 12 can include a thickness on the order of 0.8 mm to 1.0 mm, or other thickness selected according to the requirements of the substrate for a given field emission cathode structure implementation. It should be noted that a flat CRT display can contain a predetermined array of pixels, and that each pixel can contain an array of field emission cathode structures that are addressed via suitable column driver metal and line driver metal. The embodiments of the present disclosure are directed to field emission cathode structures that can be used in the pixels of a flat CRT display.

Column driver metal 14 comprises any suitable conductor, for example, including but not limited to Nichol or other suitable metal. Column driver metal 14 includes a thickness on the order of 1,000 to 4,000 angstroms, or other thickness selected according to the current carrying requirements of the column driver metal for a given field emission cathode structure implementation. The column driver metal 14 can be patterned within the field emission cathode structure according to the requirements of a given field emission cathode structure application. For example, column driver metal 14 can be patterned within a given pixel to provide a desired control of a series resistance between the column driver metal, the ballast layer, and a corresponding vertical sidewall blade (as discussed further herein below).

Ballast layer 16 comprises any suitable resistive ballast material that can act as a resistor, for example, including but not limited to amorphous silicon or the like. Ballast layer includes a thickness on the order of between 1,000 and 10,000 angstroms, or other thickness selected according to the requirements of the ballast resistance for a given field emission cathode structure implementation. Dielectric layer 18 comprises any suitable dielectric, for example, including but not limited to low cost, high quality, TEOS or the like. Dielectric layer 18 includes a thickness on the order of between 5,000 and 10,000 angstroms, or other thickness selected according to the requirements of the dielectric for a given field emission cathode structure implementation.

Line driver metal 20 comprises any suitable conductor, for example, including but not limited to Nichol or other suitable metal. Line driver metal 20 includes a thickness on the order of less than 1,000 angstroms, or other thickness selected according to the current carrying requirements of the line driver metal for a given field emission cathode structure implementation. In addition, the line driver metal 20 can be patterned within the field emission cathode structure according to the requirements of a given field emission cathode structure application.

In FIG. 2, a trench 22 is formed within field emission cathode structure 10, using any suitable patterning and etching techniques. Trench 22 is formed to have desired length and width dimensions. For example, in one embodiment, trench 22 may include a width dimension on the order of several microns (e.g., 1-3 μm). Trench 22 also extends from a top surface of the line driver layer 20, down through the line driver layer 20 and dielectric layer 18, stopping on ballast layer 16. Accordingly, the patterning and etching of trench 22 can be achieved using low cost methods.

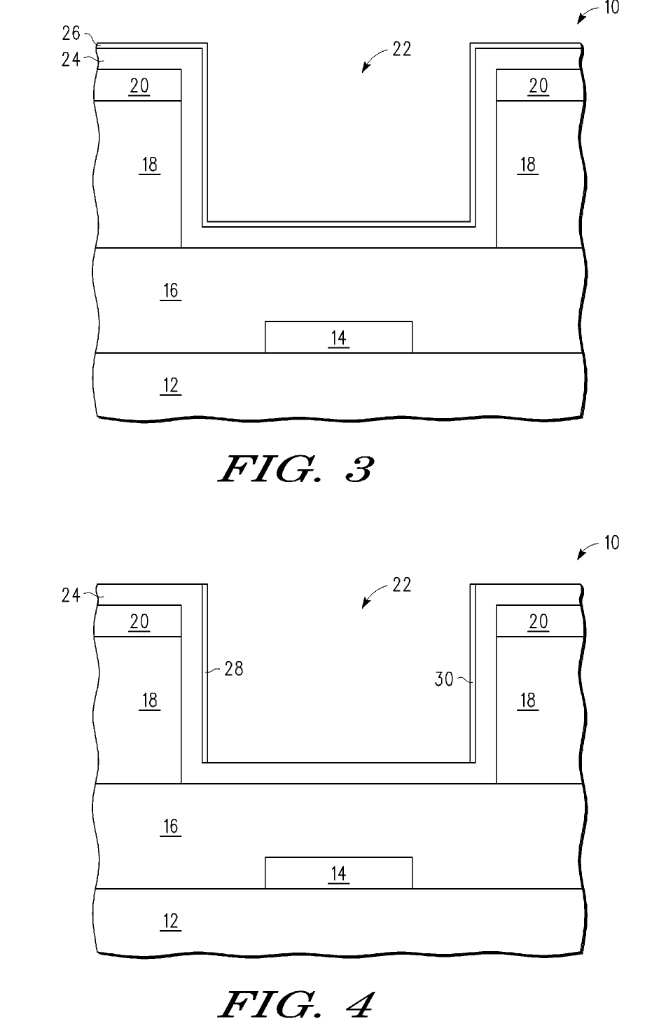

Subsequent to the formation of trench 22, as shown in FIG. 3, a conformal spacer layer 24 and a conformal blade metal layer 26 are formed overlying trench 22 and a surface of field emission cathode structure 10 outside of trench 22. Conformal spacer layer 24 can include, for example, an amorphous semiconductor layer, such as amorphous silicon. Conformal spacer layer 24 provides a substantially uniform and well controlled sidewall thickness, for example, on the order of 500 to 1000 angstroms. Conformal blade metal layer 26 can include, for example, molybdenum (Mo), niobium (Nb), or other suitable transition metal, having a thickness on the order of less than or equal to 1000 angstroms.

Following the formation of conformal spacer layer 24 and blade metal layer 26, the field emission cathode structure 10 is processed with an anisotropic blade etch. The anisotropic blade etch can include any suitable directional plasma etch, wherein horizontal components of blade metal of layer 26 are removed, leaving vertically disposed portions (28, 30) of the blade metal along sidewalls of the conformal spacer layer 24 within trench 22, as shown in FIG. 4. The method of the present disclosure thus provides for a self-aligned emitter structure. That is, formation of the sidewall blades comprises a self-aligned process in the fabrication of the emitter blade structures.

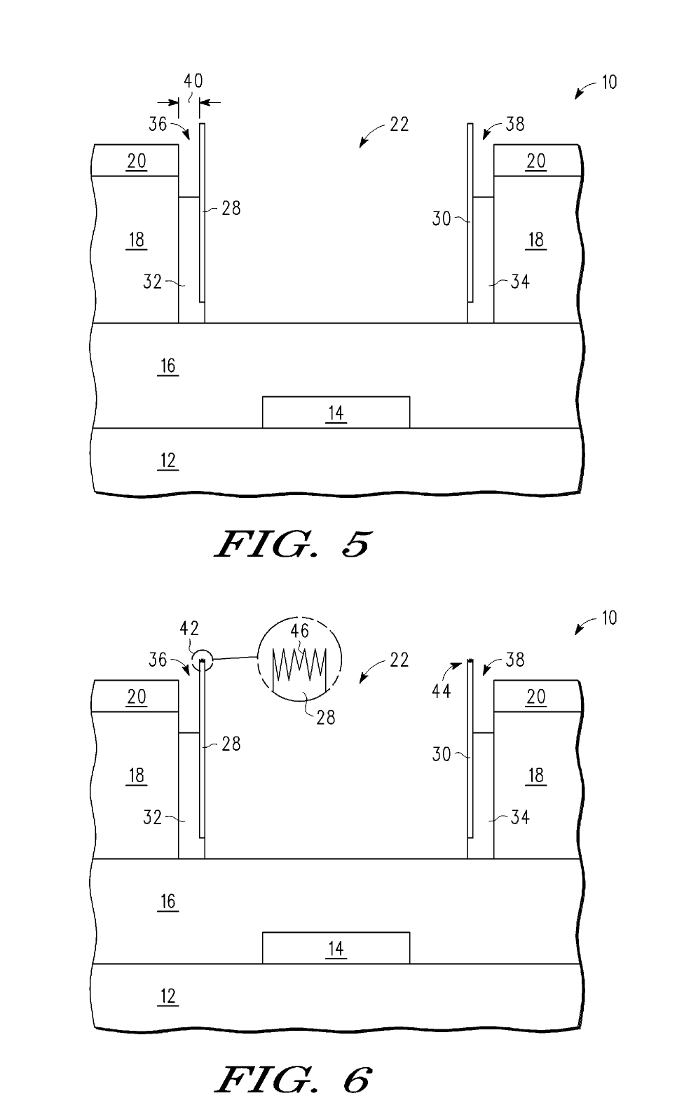

Subsequent to the anisotropic blade etch, the structure is processed via a suitable spacer etch. The spacer etch removes portions of the conformal spacer layer 24, for example, portions previously occupied within recessed regions 36 and 38 and a bottom of the trench 22, and leaves remaining portions of sidewall spacers 32 and 34, as shown in FIG. 5. The spacer etch comprises any suitable anisotropic etch for etching a desired portion of the spacer material overlying the line metal layer 20 and form the recessed regions 36 and 38 between a corresponding sidewall of line metal layer 20 and sidewall blades 28 and 30, respectively. The recessed regions 36 and 38 are of sufficient depth to prevent any undesired shorting between the line metal layer 20 and the corresponding sidewall blade 28 or 30. In one embodiment, recessed regions 36 and 38 correspond to the spacer layer being recessed from a top surface of line metal layer 20 by an amount on the order of one-fourth to one-third of the thickness of dielectric layer 18.

In addition, the thickness of the spacer layer 24 as indicated by reference numeral 40 advantageously establishes a desired spacing of the vertical sidewall blade (28, 30) from the sidewall of the trench 22, as well as, spacing of the vertical sidewall blade from an edge of the line metal layer 20. The spacing is selected as a function of a voltage to be applied between the vertical sidewall blade and the line metal layer. Furthermore, during operation, the electric field at the tip of the vertical sidewall blade varies inversely with respect to the spacing.

FIG. 6 is a cross-sectional view of the field emission cathode structure 10 featuring blade emitters formed with emission enhanced blade tips (42, 44) according to another embodiment of the present disclosure. In particular, the field emission cathode structure 10 of FIG. 5 is further processed to form emission enhanced blade tips (42, 44). In one embodiment, enhancement of the blade tips can be accomplished using plasma etching, and more particularly, using a violent, non-uniform, flash plasma etch. In another embodiment, the structuring of the blade can be achieved with a metal pitting wet etch.

For example, in FIG. 6, tip 42 of blade 28 includes a roughened surface 46 that is characterized by peaks and valleys as illustrated in enlarged detail. Furthermore, the emission enhancement obtained by the roughened surface 46 advantageously increases the Fowler Nordheim electron extraction effect between the vertical sidewall blade and its corresponding line metal layer during operation of the field emission cathode structure 10, versus a tip not subject to the emission enhancement treatment. In addition, the emission enhancement provides an increase in efficiency on the order of ten times (10×) over prior known field emission cathode structures.

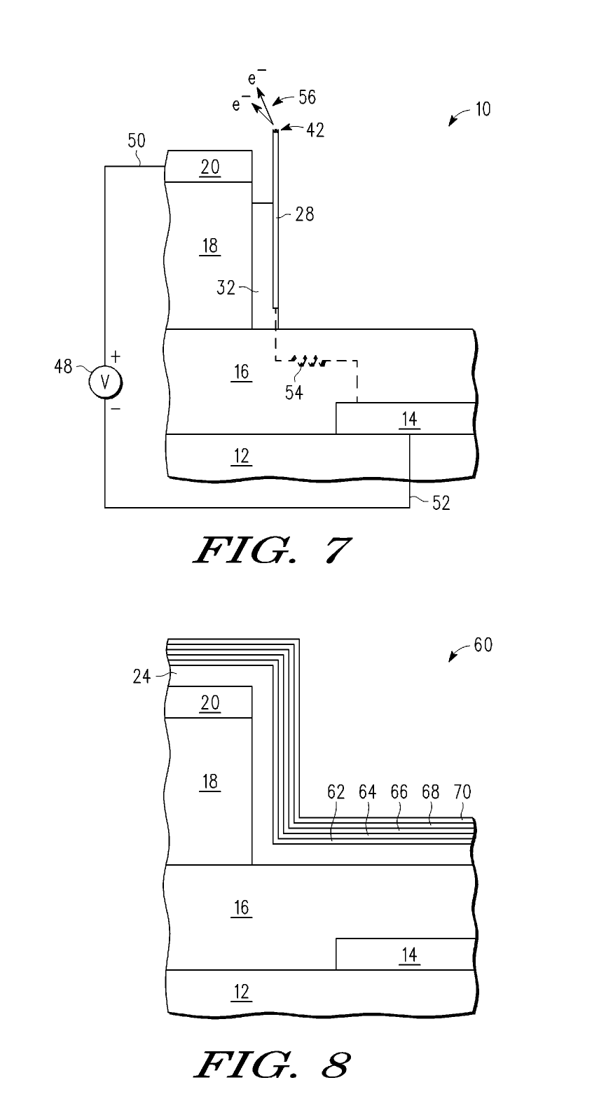

FIG. 7 is a partial cross-sectional and schematic view of a portion of the field emission cathode structure of FIG. 6 illustrating Fowler-Nordheim tunneling extraction of electrons from the emission enhanced blade tips. A voltage supply, as indicated by reference numeral 48, can be coupled to the field emission cathode structure, wherein positive potential can be provided to the line metal layer 20 via line 50 and a negative (or opposite potential) can be provided to the column metal layer 14 via line 52. Blade 28 is electrically coupled to column metal layer 14 through the ballast layer 16 and sidewall spacer 32 by an effective resistance, as indicated by reference numeral 54. Ballast layer 16 also assists with providing for a given level of reliability for the cathode structure device. In response to application of an appropriate voltage V to the field emission cathode structure, electron emission 56 is produced. Characteristics and dimensions of the line metal layer, vertical sidewall blade, sidewall spacer, and column metal layer are selected according to requirements of a given field emission cathode structure application and Fowler-Nordheim Tunneling extraction specification.

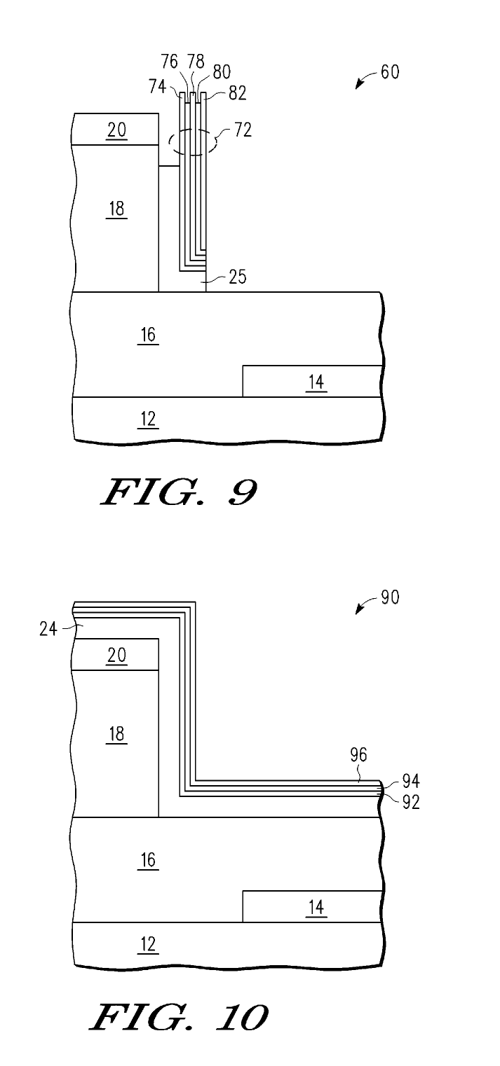

FIGS. 8-9 are cross-sectional views of a portion of field emission cathode structure 60 featuring blade emitters at various stages of manufacture thereof and which is formed according to another embodiment of the present disclosure. The embodiment of FIG. 8 begins with the fabrication of the field emission cathode structure as discussed herein with reference to FIGS. 1-2. Subsequent to the formation of conformal spacer layer 24, as shown in FIG. 8, a plurality of conformal blade metal layers (62, 64, 66, 68, and 70) are formed overlying conformal spacer layer 24 within the trench and on a surface of conformal spacer layer 24 of the field emission cathode structure 60 outside of the trench. The plurality of conformal blade metal layers can contain any number of desired conformal blade metal layers, wherein the number of conformal blade metal layers of the plurality of layers is selected according to the requirements of a given field emission cathode structure application. In one embodiment, the plurality of conformal blade metal layers comprises at least two conformal blade metal layers in which one of the conformal blade metal layers has a first etch characteristic and the other of the conformal blade metal layers has a second etch characteristic, wherein the first etch characteristic differs from the second etch characteristic.

The total thickness of the plurality of conformal blade metal layers (62, 64, 66, 68, and 70) can be on the order of less than or equal to 1000 angstroms. The first conformal blade metal layer 62 can include, for example, molybdenum (Mo), niobium (Nb), or other suitable transition metal, having a thickness that is a first percentage of the total thickness of the plurality of conformal blade metal layers. In one embodiment, the first conformal blade metal layer 62 is formed via suitable vacuum deposition techniques. The second conformal blade metal layer 64 can include, for example, molybdenum (Mo), niobium (Nb), or other suitable transition metal, having a thickness that is a second percentage of the total thickness of the plurality of conformal blade metal layers. In one embodiment, the second conformal blade metal layer 64 comprises the same material as the first conformal blade metal layer 62; however, it is formed via suitable vacuum deposition techniques different from the first conformal blade metal layer 62 such that the second conformal blade metal layer 64 has etch characteristics different from the etch characteristics of the first conformal blade metal layer 62. For example, second conformal blade metal layer 64 could be formed via suitable vacuum deposition techniques that include the addition of oxygen to produce a slightly oxidized metal.

In a similar manner, third, fourth, and fifth conformal blade metal layers 66, 68, and 70 are formed, wherein the etch characteristics of each is different from the etch characteristics of an adjoining layer. The individual layers of the conformal blade metal of the plurality of layers can have similar thicknesses to one another or different thickness to one another. In addition, the percentage thickness of each conformal blade metal layer of the plurality of layers cumulatively adds up to one-hundred percent of the total thickness of the plurality of conformal blade metal layers.

Subsequent to the formation of the plurality of conformal blade metal layers (62, 64, 66, 68, and 70), the field emission cathode structure 60 is processed with an anisotropic blade etch. The anisotropic blade etch can include any suitable directional plasma etch, wherein horizontal components of blade metal of the plurality of conformal blade metal layers (62, 64, 66, 68, and 70) are removed, leaving vertically disposed cumulative blade 72 that includes portions (74, 76, 78, 80, and 82) of the blade metal along sidewalls of the conformal spacer layer 24 within the trench. The method of the present disclosure thus provides for a self-aligned emitter structure. That is, formation of the cumulative sidewall blade comprises a self-aligned process in the fabrication of the emitter blade structures.

The tip of the cumulative emitter blade 72 advantageously provides for enhanced electron emission. That is, the field emission cathode structure 60 features a cumulative blade emitter formed with emission enhanced blade tips, wherein the height of individual ones of the blades of the cumulative emitter blade 72 varies in a manner that provides for emission enhancement. In particular, the field emission cathode structure 60 of FIG. 9, by virtue of the make-up of the plurality of conformal blade metal layers and during etching to form the cumulative emitter blade 72, the resultant blade structure forms an emission enhanced blade tip. For example, in FIG. 9, the tip of cumulative emitter blade 72 includes a roughened surface that is characterized by peaks and valleys. Furthermore, the emission enhancement obtained by the roughened surface advantageously increases the Fowler Nordheim electron extraction effect between the vertical sidewall blade and its corresponding line metal layer during operation of the field emission cathode structure 60, versus a tip not subject to the emission enhancement treatment. In addition, the emission enhancement provides an increase in efficiency on the order of ten times (10×) over prior known field emission cathode structures.

Subsequent to the anisotropic blade etch, the structure 60 is processed via a suitable spacer etch. The spacer etch removes portions of the conformal spacer layer 24, for example, portions previously occupied within recessed regions and a bottom of the trench, and leaves remaining portions of the sidewall spacer 25, as shown in FIG. 9. The spacer etch comprises any suitable wet or isotropic etch for etching a desired portion of the spacer material overlying the line metal layer 20 and form the recessed regions between a corresponding sidewall of line metal layer 20 and cumulative sidewall blade 72. The recessed regions are of sufficient depth to prevent any undesired shorting between the line metal layer 20 and the corresponding cumulative sidewall blade 72. In one embodiment, recessed regions correspond to the spacer layer being recessed from a top surface of line metal layer 20 by an amount on the order of one-fourth to one-third of the thickness of dielectric layer 18.

FIGS. 10-12 are cross-sectional views of a portion of a field emission cathode structure featuring blade emitters at various stages of manufacture thereof and which is formed according to yet another embodiment of the present disclosure. The embodiment of FIG. 10 begins with the fabrication of the field emission cathode structure as discussed herein with reference to FIGS. 1-2. In this embodiment, the field emission cathode structure includes a conductive adhesion layer, a grapheme layer, and a protective capping layer as discussed hereinafter. Subsequent to the formation of conformal spacer layer 24, as shown in FIG. 10, a conductive adhesion layer 92 is formed overlying conformal spacer layer 24 within the trench and on a surface of conformal spacer layer 24 of the field emission cathode structure 90 outside of the trench. Adhesion layer 92 can include any suitable thin conductive layer configured for providing a desired adhesion for a subsequently formed blade metal layer. For example, adhesion layer 92 can include amorphous silicon having a thickness on the order of between ten and fifty angstroms (10-50 Å), having been formed by atomic layer deposition.

Subsequent to the formation of adhesion layer 92, a conformal blade metal layer 94 is formed overlying adhesion layer 92. Conformal blade metal layer 94 includes for example, grapheme having a thickness on the order of five angstroms (5 Å), having been formed by atomic layer deposition. Subsequent to the formation of blade metal layer 94, a conformal protective cap layer 96 is formed overlying blade metal layer 94. Conformal protective cap layer 96 includes any suitable protective cap layer, for example, silicon oxide or other oxide, having a thickness on the order of ten to fifty angstroms (10-50 Å), having been formed by atomic layer deposition.

Subsequent to the formation of the protective cap layer 96, the field emission cathode structure 90 are processed with an anisotropic blade etch. The anisotropic blade etch can include any suitable directional plasma etch, wherein horizontal components of the adhesive, blade metal, and protective cap layers are removed, leaving vertically disposed cumulative sidewall blade 98 comprising portions 100, 102, and 104 of the adhesive, blade metal, and protective cap layers, respectively, along sidewalls of the conformal spacer layer 24 within the trench. The method of the present disclosure thus provides for a self-aligned emitter structure. That is, formation of the cumulative sidewall blade comprises a self-aligned process in the fabrication of the emitter blade structures.

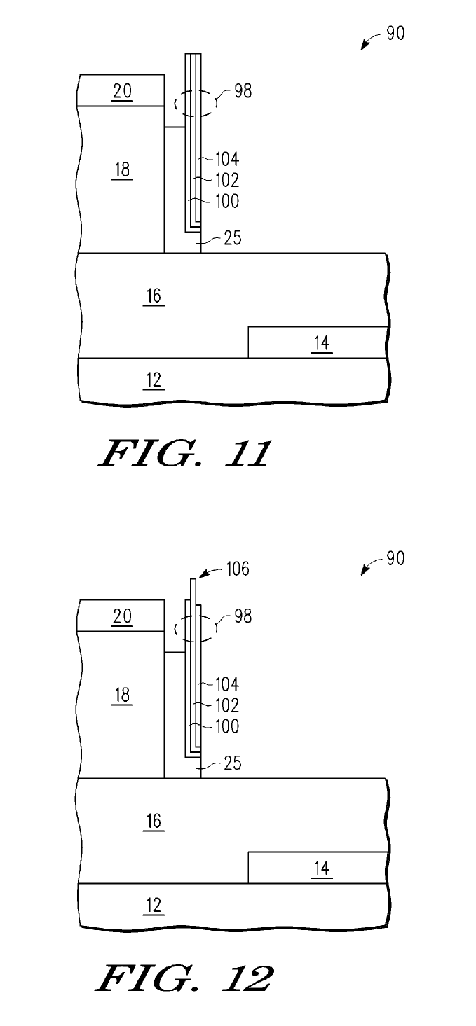

Subsequent to the anisotropic blade etch, the structure 90 is processed via a suitable spacer etch. The spacer etch removes portions of the conformal spacer layer 24, for example, portions previously occupied within recessed regions and a bottom of the trench, and leaves remaining portions of the sidewall spacer 25, as shown in FIG. 11. The spacer etch comprises any suitable anisotropic etch for etching a desired portion of the spacer material overlying the line metal layer 20 and form the recessed regions between a corresponding sidewall of line metal layer 20 and cumulative sidewall blade 98. The recessed regions are of sufficient depth to prevent any undesired shorting between the line metal layer 20 and the corresponding cumulative sidewall blade 98. In one embodiment, recessed regions correspond to the spacer layer being recessed from a top surface of line metal layer 20 by an amount on the order of one-fourth to one-third of the thickness of dielectric layer 18.

FIG. 12 is a cross-sectional view of the field emission cathode structure 90 featuring a blade emitter formed with an emission enhanced blade tip 106 according to another embodiment of the present disclosure. In particular, the field emission cathode structure 90 of FIG. 11 is further processed to form emission enhanced blade tip 106. In one embodiment, enhancement of the blade tip of FIG. 11 can be accomplished using wet chemical etching, and more particularly, using a wet chemical etch selected to remove a portion of the adhesion layer 100 (e.g. amorphous silicon) and a portion of the protective cap layer 104 (e.g., an oxide), while not adversely affecting the grapheme layer 102. For example, in FIG. 12, tip 106 of blade 98 includes a roughened surface that is characterized by peaks and valleys. Furthermore, emission enhancement obtained by the roughened surface advantageously increases the Fowler Nordheim electron extraction effect between the vertical sidewall blade and its corresponding line metal layer during operation of the field emission cathode structure 90, versus a tip not subject to the emission enhancement treatment. In addition, the emission enhancement provides an increase in efficiency on the order of at least ten times (10×) over prior known field emission cathode structures.

By now it should be appreciated that there has been provided a method for making a field emission cathode structure that comprises: forming a ballast layer over a column metal layer; forming a dielectric layer over the ballast layer; forming a line metal layer over the dielectric layer; forming a trench in the line metal layer and the dielectric layer, the trench extending to the ballast layer; and forming a sidewall spacer and a sidewall blade adjacent a sidewall of the trench, wherein the sidewall spacer is between the dielectric layer and the sidewall blade, and wherein the conformal spacer is recessed as compared to the sidewall blade such that a gap is present between the sidewall blade and the line metal layer. In another embodiment, a major surface of the sidewall blade is substantially perpendicular to a major surface of the line metal layer. The method further comprises roughening a tip of sidewall blade.

In yet another embodiment, the sidewall blade comprises a first metal layer and a second metal layer, wherein the first metal layer is a different metal than the second metal layer. In addition, the first metal layer is recessed as compared to the second metal layer. The method further comprises providing a substrate, wherein the column layer is formed over the substrate, and wherein a major surface of the sidewall blade is substantially perpendicular to a major surface of the substrate. In a further embodiment, the sidewall blade can comprise one of a metal, grapheme, or diamond-like-carbon.

In another embodiment, a method for making a field emission cathode structure comprises: forming a ballast layer over a column metal layer; forming a dielectric layer over the ballast layer; forming a line metal layer over the dielectric layer; forming a trench in the line metal layer and the dielectric layer, the trench extending to the ballast layer; forming a conformal spacer layer over the line metal layer and ballast layer, wherein the conformal spacer layer is conformal to a sidewall of the trench; forming a blade metal layer over the conformal spacer layer; removing portions of the blade metal layer to form a sidewall metal blade adjacent a sidewall of the trench; and removing portions of the conformal spacer layer to form a gap between the line metal layer and the sidewall metal blade, wherein a remaining portion of the conformal spacer layer remains between the dielectric layer and the sidewall metal blade. In one embodiment, the width of the trench is on the order of at least one micron.

In another embodiment, the method further comprises providing a substrate, wherein the column metal layer is formed over the substrate, and wherein a major surface of the sidewall metal blade is substantially perpendicular to a major surface of the substrate. In another embodiment, the method further comprises roughening a tip of the sidewall metal blade, wherein the roughening the tip of the sidewall metal blade comprises performing a plasma etch or wet pitting on the sidewall metal blade after the removing portions of the conformal spacer layer to form the gap.

In one embodiment, forming the blade metal layer over the conformal spacer layer comprises forming a first blade metal layer over the conformal spacer layer and a second blade metal layer over the first blade metal layer, and wherein the removing the portions of the blade metal layer comprises removing portions of the first blade metal layer and the second blade metal layer, wherein the sidewall metal blade is further characterized as a multiple layer blade. In another embodiment, the first blade metal layer is a different metal than the second blade metal layer. Furthermore, in yet another embodiment, after the removing the portions of the first blade metal layer and the second blade metal layer, a remaining portion of the first blade metal layer has a different height than a remaining portion of the second blade metal layer.

In one embodiment, a field emission cathode structure comprises a ballast layer over a column metal layer; a dielectric layer over the ballast layer; a line metal layer over the dielectric layer; a trench extending through the line metal layer and the dielectric layer to the ballast layer; a sidewall spacer adjacent a sidewall of the trench; and a sidewall blade adjacent the sidewall spacer, wherein the sidewall spacer is between the dielectric layer and the sidewall blade, and wherein a gap is present between the line metal layer and the sidewall blade. In one embodiment, the sidewall blade comprises a material selected from a group consisting of metal, grapheme, and diamond-like-carbon. In another embodiment, the sidewall blade comprises a plurality of different metal layers.

Although the invention has been described with respect to specific conductivity types or polarity of potentials, skilled artisans appreciated that conductivity types and polarities of potentials may be reversed.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Although the invention is described herein with reference to specific embodiments, various modifications and changes can be made without departing from the scope of the present invention as set forth in the claims below. For example, the embodiments of the present disclosure can also be used for MEMS, sensors, SMARTMOS, and the like. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for making a field emission cathode structure comprising:
forming a ballast layer over a column metal layer;
forming a dielectric layer over the ballast layer;
forming a line metal layer over the dielectric layer;
forming a trench in the line metal layer and the dielectric layer, the trench extending to the ballast layer; and
forming a sidewall spacer and a sidewall blade adjacent a sidewall of the trench, wherein the sidewall spacer is between the dielectric layer and the sidewall blade, and wherein the conformal spacer is recessed as compared to the sidewall blade such that a gap is present between the sidewall blade and the line metal layer.

2. The method of claim 1, wherein a major surface of the sidewall blade is substantially perpendicular to a major surface of the line metal layer.

3. The method of claim 1, further comprising:
roughening a tip of sidewall blade.

4. The method of claim 1, wherein the sidewall blade comprises a first metal layer and a second metal layer.

5. The method of claim 4, wherein the first metal layer is a different metal than the second metal layer.

6. The method of claim 4, wherein the first metal layer is recessed as compared to the second metal layer.

7. The method of claim 1, further comprising:
providing a substrate, wherein the column layer is formed over the substrate, and wherein a major surface of the sidewall blade is substantially perpendicular to a major surface of the substrate.

8. The method of claim 1, wherein the sidewall blade comprises a metal.

9. The method of claim 1, wherein the sidewall blade comprises grapheme or diamond-like-carbon.

10. A method for making a field emission cathode structure comprising:
forming a ballast layer over a column metal layer;
forming a dielectric layer over the ballast layer;
forming a line metal layer over the dielectric layer;
forming a trench in the line metal layer and the dielectric layer, the trench extending to the ballast layer;
forming a conformal spacer layer over the line metal layer and ballast layer, wherein the conformal spacer layer is conformal to a sidewall of the trench;
forming a blade metal layer over the conformal spacer layer;
removing portions of the blade metal layer to form a sidewall metal blade adjacent a sidewall of the trench; and
removing portions of the conformal spacer layer to form a gap between the line metal layer and the sidewall metal blade, wherein a remaining portion of the conformal spacer layer remains between the dielectric layer and the sidewall metal blade.

11. The method of claim 10, further comprising:
providing a substrate, wherein the column metal layer is formed over the substrate, and wherein a major surface of the sidewall metal blade is substantially perpendicular to a major surface of the substrate.

12. The method of claim 10, further comprising roughening a tip of the sidewall metal blade.

13. The method of claim 12, wherein the roughening the tip of the sidewall metal blade comprises performing a plasma etch or wet pitting on the sidewall metal blade after the removing portions of the conformal spacer layer to form the gap.

14. The method of claim 10, wherein the forming the blade metal layer over the conformal spacer layer comprises forming a first blade metal layer over the conformal spacer layer and a second blade metal layer over the first blade metal layer, and wherein the removing the portions of the blade metal layer comprises removing portions of the first blade metal layer and the second blade metal layer, wherein the sidewall metal blade is further characterized as a multiple layer blade.

15. The method of claim 14, wherein the first blade metal layer is a different metal than the second blade metal layer.

16. The method of claim 14, wherein after the removing the portions of the first blade metal layer and the second blade metal layer, a remaining portion of the first blade metal layer has a different height than a remaining portion of the second blade metal layer.

17. The method of claim 10, wherein a width of the trench is at least one micron.

18. A field emission cathode structure comprising:
a ballast layer over a column metal layer;
a dielectric layer over the ballast layer;
a line metal layer over the dielectric layer;
a trench extending through the line metal layer and the dielectric layer to the ballast layer;
a sidewall spacer adjacent a sidewall of the trench; and
a sidewall blade adjacent the sidewall spacer, wherein the sidewall spacer is between the dielectric layer and the sidewall blade, and wherein a gap is present between the line metal layer and the sidewall blade.

19. The field emission cathode structure of claim 18, wherein the sidewall blade comprises a material selected from a group consisting of metal, grapheme, and diamond-like-carbon.

20. The field emission cathode structure of claim 18, wherein the sidewall blade comprises a plurality of different metal layers.
